(19) United States
(12) Patent Application Publication
(10) Pub. No.: US 2025/0332759 A1
(43) Pub. Date: Oct. 30, 2025

(54) THERMOCHEMICALLY ACTIVATED DRY CONCRETE FORMULATION

(71) Applicant: University of Alaska Fairbanks, Fairbanks, AK (US)

(72) Inventor: Nima Farzadnia, Fairbanks, AK (US)

(21) Appl. No.: 19/194,724

(22) Filed: Apr. 30, 2025

Related U.S. Application Data
(60) Provisional application No. 63/640,682, filed on Apr. 30, 2024.

(51) Int. Cl. B28B 11/24; B28B 1/00; B33Y 10/00; C04B 7/153; C04B 28/02; C04B 40/00; C04B 111/00

(52) U.S. Cl. CPC B28B 11/245; B28B 1/001; C04B 7/1535; C04B 28/021; C04B 40/0082; C04B 40/0089; B33Y 10/00; C04B 2111/00068; C04B 2111/00181

(57) ABSTRACT

Disclosed are dry methods of making a composite concrete material using a water-free precursor composition. Also disclosed herein are composite concrete materials.

### CROSS-REFERENCE TO RELATED APPLICATIONS

This application claims the benefit of U.S. Provisional Application No. 63/640,682, filed on Apr. 30, 2024, which is incorporated herein by reference in its entirety.

### BACKGROUND

Concrete is a composite material typically containing aggregate, such as mineral particulates, bound together with a fluid cement that cures to a solid over time. It is the most widely used building material, and the most manufactured material in the world. Conventionally, aggregate is mixed with dry Portland cement and water to form a fluid slurry. The slurry is then poured and molded into the desired shape. The process yields a composite concrete material which has a relatively high compressive strength and high durability. Typically, this process requires the addition of water to form the fluid slurry. Such processes are unsuitable for construction processes in settings with scarce water, such as extraterrestrial construction settings. The conventional process also typically requires several days to fully cure the concrete. Such methods are unsuitable for use in regions where accelerated construction is desired, such as areas with frigid temperatures, post-disaster areas, or for defense system applications.

Therefore, there remains a need in the art for composite materials, such as concrete composite materials, which can be produced without the addition of water. There also remains a need in the art for methods which produce composite concrete materials which can be cured at a faster rate, such as 2-12 hours, compared to conventional processes, which typically require several days to fully cure. Such needs are addressed herein.

### SUMMARY

In accordance with the purpose(s) of the invention as embodied and broadly described herein, the invention, in one aspect, relates to methods of making a composite material, such as a concrete composite material.

Disclosed herein is a dry method of making a composite concrete material, the method comprising: a) providing a water-free precursor composition which comprises by weight of the composition: i) 60% to 90% of a regolith simulant material or an aluminosilicate material; ii) 10% to 30% of a salt, wherein the salt is NaNO₃, KNO₃, LiNO₃, Li₂CO₃, K₂CO₃, Na₂CO₃, or a combination thereof; and iii) less than 20% of a base, wherein the total weight percent amount of components i), ii), and iii) does not exceed 100%, b) heating the precursor composition to a temperature sufficient to moltenize the salt, thereby providing a heated mixture; and c) curing the heated mixture to form the composite concrete material.

Also disclosed herein is a composite concrete material formed by the methods disclosed herein.

Also disclosed herein is a water-free composite precursor composition comprising, by weight of the composition: a) from 60% to 90% of a regolith simulant material or an aluminosilicate material; b) from 10% to 30% of a salt being NaNO₃, KNO₃, LiNO₃, Li₂CO₃, K₂CO₃, or Na₂CO₃; and c) less than 20% of a base being NaOH, KOH, CaO or MgO, wherein the total weight percent amount of components i), ii), and iii) does not exceed 100%.

Additional aspects of the invention will be set forth, in part, in the detailed description, and claims that follow, and in part will be derived from the detailed description, or can be learned by practice of the invention. It is to be understood that both the foregoing general description and the following detailed description are exemplary and explanatory only and are not restrictive of the invention as disclosed.

### BRIEF DESCRIPTION OF DRAWINGS

FIG. 1A is a representative photograph of a composite concrete material obtained by the methods described herein.

FIG. 1B is a representative image showing a polymeric structure obtained by the disclosed method. The composite was formed using lunar regolith stimulant, NaOH, and NaNO₃ at 350° C. for a heating time of 3 hours.

### DETAILED DESCRIPTION

The present invention can be understood more readily by reference to the following detailed description, examples, drawings, and claims, and their previous and following description. However, before the present materials, systems, and/or methods are disclosed and described in further detail, it is to be understood that this invention is not limited to the specific or exemplary aspects of materials, systems, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known aspect. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those of ordinary skill in the pertinent art will recognize that many modifications and adaptations to the present invention are possible and may even be desirable in certain circumstances and are a part of the present invention. Thus, the following description is again provided as illustrative of the principles of the present invention and not in limitation thereof.

As used herein, the singular forms “a,” “an” and “the” include plural referents unless the context clearly dictates otherwise. Thus, for example, reference to a “regolith simulant material” includes aspects having two or more such regolith stimulant materials unless the context clearly indicates otherwise.

As used herein, the term “comprising” can include the aspects “consisting of” and “consisting essentially of.” The term “comprising” can also mean “including but not limited to.”

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It should be further understood that the endpoints of each of the ranges are significant both in relation to the other endpoint, and independently of the other endpoint. Moreover, in still further aspects, reference to a parameter that equals a particular endpoint or specific value also includes aspects that are characterized as being greater than the stated value or, alternatively, less than the stated value.

As used herein, the terms “optional” or “optionally” mean that the subsequently described event or circumstance may or may not occur, and that the description includes instances where said event or circumstance occurs and instances where it does not.

As used herein, the term “water-free,” such as in reference to “water-free precursor composition,” means that the precursor composition contains at most incidental or trace amounts of water. The precursor composition may contain water in trace amounts of, for example, less than 1%, 0.9%, 0.8%, 0.7%, 0.6%, 0.5%, 0.4%, 0.3%, 0.2%, or less than 0.1% by weight of the precursor composition. Such trace amounts of water are not added as a separate component of the precursor composition, but can be present as a contaminant in other components of the precursor composition. In some aspects, the precursor composition comprises less than 0.5% water by weight.

As used herein, the term “regolith simulant material” refers to a terrestrial material which mimics the chemical, mechanical, and/or mineralogical characteristics of regolith, the layer of loose, crushed material that covers the surface of planetary bodies. The regolith simulant material can be, for example, a lunar regolith simulant material, a Martian regolith simulant material, or an asteroidal regolith simulant material. The regolith simulant material can contain synthesized simulant material, naturally occurring material, or a combination thereof.

The present invention may be understood more readily by reference to the following detailed description of various aspects of the invention and the examples included therein and to the Figures and their previous and following description.

### Methods of Making a Composite Concrete Material

In various aspects, the disclosure herein relates to dry methods of making a composite concrete material, the method comprising: a) providing a water-free precursor composition which comprises by weight of the composition: i) 60% to 90% of a regolith simulant material or an aluminosilicate material; ii) 10% to 30% of a salt, wherein the salt is NaNO₃, KNO₃, LINO₃, Li₂CO₃, K₂CO₃, Na₂CO₃, or a combination thereof; and iii) less than 20% of a base, wherein the total weight percent amount of components i), ii), and iii) does not exceed 100%, b) heating the precursor composition to a temperature sufficient to moltenize the salt, thereby providing a heated mixture; and c) curing the heated mixture to form the composite concrete material.

The method described herein uses a thermochemical activation process that combines alkali activation technology with thermal processing in the presence of molten salts. Compared to conventional concrete material processes, the method described herein eliminates the requirement of adding water to form the composite concrete material. Furthermore, conventional concrete material methods typically require several days for production, curing, and use. In contrast, a composite concrete material produced using the described method can be produced and used in the matter of hours, such as 2-12 hours.

Alkali-activation is a proven process of accelerating the dissolution rate and reactivity of aluminosilicates (e.g., fly ash and slag), also known as precursors, by adding water-based alkali activators, i.e., bases, (e.g., NaOH, Na₂CO₃, Na₂O (SiO₂)ₙ). This facilitates the dissolution of glassy phases of aluminosilicates through OH ions attacking Si—O—Si and Al—O—Si bonds. As a result, calcium and aluminosilicate ions are released into the system. As the concentrations of these species increase, calcium-silicate and/or aluminosilicate species start to polymerize to form colloidal particles, which grow and eventually precipitate to form the binder phase of concrete. This conventional technology relies heavily on water to provide the high alkalinity in the systems.

Molten salts are renowned for their ability to dissolve a wide range of inorganic and organic compounds, including aluminosilicates. When a solid salt transitions to a molten state, it forms a solution of cations and anions, effectively serving as a solvent for chemical reactions and eliminates the requirement for water. Molten salts are found in energy storage systems (e.g., researchable batteries). Without wishing to be bound by theory, thermal processing combined with the use of molten alkali salts (e.g., NaNO₃, KNO₃), provides the necessary dissolving energy to break down regolith structure without the need for water. This process results in development of a uniform molecular structure upon the polymerization of the dissolved species in regolith, such as SiO₂, Al₂O₃, and CaO, to form a robust composite concrete material suitable for, for example, extraterrestrial construction. Further, a vacuum curing process can be used to employ induced vacuum suction to further improve the engineering properties of the composite. In various aspects, the method does not comprise adding water.

### A. Precursor Compositions

The method described herein comprises providing a water-free precursor composition which comprises by weight of the composition: i) 60% to 90% of a regolith simulant material or an aluminosilicate material; ii) 10% to 30% of a salt, wherein the salt is NaNO₃, KNO₃, LiNO₃, Li₂CO₃, K₂CO₃, Na₂CO₃, or a combination thereof; and iii) less than 20% of a base, wherein the total weight percent amount of components i), ii), and iii) does not exceed 100%. It is noted that combining salts to form a eutectic system may lower the melting point, reduce viscosity for easier mixing, and/or enhance the dissolving capacity.

In various aspects, the precursor composition comprises, by weight of the composition, 60% to 90% of a regolith simulant material. The regolith simulant material can be present in an amount of, for example, from 60% to 85%, 60% to 80%, 60% to 75%, 60% to 70%, 60% to 65%, 65% to 90%, 65% to 90%, 65% to 85%, 65% to 80%, 65% to 75%, 65% to 70%, 70% to 90%, 70% to 85%, 70% to 80%, 70% to 75%, 75% to 90%, 75% to 85%, 75% to 80%, 80% to 90%, or 80% to 85% by weight of the precursor composition. The regolith simulant material can be present in an amount of, for example, at least 60%, 65%, 70%, 75%, 80%, or at least 85% by weight of the precursor composition.

In various aspects, the precursor composition comprises, by weight of the composition, 60% to 90% of an aluminosilicate material. As used herein, “aluminosilicate material” refers to a material containing oxides of both silicon and aluminum, and typically containing anionic Si—O—Al linkages. The aluminosilicate material can be present in an amount of, for example, 60% to 85%, 60% to 80%, 60% to 75%, 60% to 70%, 60% to 65%, 65% to 90%, 65% to 90%, 65% to 85%, 65% to 80%, 65% to 75%, 65% to 70%, 70% to 90%, 70% to 85%, 70% to 80%, 70% to 75%, 75% to 90%, 75% to 85%, 75% to 80%, 80% to 90%, or 80% to 85% by weight of the precursor composition. The aluminosilicate material can be present in an amount of, for example, at least 60%, 65%, 70%, 75%, 80%, or at least 85% by weight of the precursor composition.

Non-limiting examples of suitable aluminosilicate materials include fly ash, slag, silt, a clayey soil, volcanic ash, kaolinite, feldspar, zeolites, clay minerals, montmorillonite, andalusite, kyanite, sillimanite, or a combination thereof. In various aspects, the aluminosilicate material is fly ash, slag, silt, a clayey soil, volcanic ash, or a combination thereof.

The precursor composition comprises, by weight of the composition, 10% to 30% of a salt, wherein the salt is NaNO₃, KNO₃, LiNO₃, Li₂CO₃, K₂CO₃, Na₂CO₃, or a combination thereof. Such salts transition into a molten salt when heated to a sufficient temperature in step b). In some aspects, the salt is NaNO₃. The salt can be present in an amount of, for example, 10% to 25%, 10% to 20%, 10% to 15%, 15% to 30%, 15% to 25%, 15% to 20%, 20% to 30%, 20% to 25%, or 25% to 30% by weight of the precursor composition.

The precursor composition comprises, by weight of the composition, less than about 20% of a base. In some aspects, the composition does not comprise a base. In various aspects, the composition comprises a base. When present, the base can be any compound which is a basic, ionic salt of an alkali or an alkaline earth metal. In various aspects, the base is NaOH, KOH, CaO or MgO. The base can present in an amount of, for example, less than 18%, 15%, 10%, 5%, 4%, 3%, 2%, or less than 1% by weight of the precursor composition. The base can be present in an amount of, for example, 0.1% to 20%, 0.1% to 18%, 0.1% to 15%, 0.1% to 10%, 0.1% to 5%, 0.1% to 1%, 0.1% to 0.5%, 0.5% to 20%, 0.5% to 18%, 0.5% to 15%, 0.5% to 10%, 0.5% to 5%, 0.5% to 1%, 1% to 20%, 1% to 15%, 1% to 10%, 1% to 5%, 5% to 20%, 5% to 15%, 5% to 10%, 10% to 20%, 10% to 15%, or 15% to 20% by weight of the precursor composition.

In some aspects, the precursor composition is a dry mix, i.e., there are no fluid components in the precursor composition. In such aspects, each of components i), ii), and iii) can be present in the precursor composition as a powder. In a further aspect, each of components i), ii), and iii) comprise particles having a mean particle diameter of less than 400 μm. Each of components i), ii), and iii) can comprise particles having a mean particle diameter of, for example, less than 350 μm, 300 μm, 200 μm, 100 μm, or less than 50 μm. In a yet still further aspect, the base is ground into a powder prior to step a).

### B. Heating the Precursor Composition

The precursor composition is heated to a temperature sufficient to moltenize the salt, thereby providing a heated mixture in step b). Advantageously, the salt in the precursor composition typically transitions into a molten state at temperatures lower than temperatures used for conventional molten or sintering techniques (1000° C. or more). Thus, the precursor composition can be heated at any temperature sufficient for the salt to moltenize. As discussed above, heating combined with the use of molten alkali salts (e.g., NaNO₃, KNO₃), provides the necessary dissolving energy to break down regolith structure without the need for water.

In one aspect, step b) is performed at a temperature less than 1000° C., such as less than 950° C., 900° C., 850° C., 800° C., 750° C., 700° C., 650° C., 600° C., 550° C., 500° C., 450° C., or less than 400° C. In some aspects, step b) is performed at a temperature of 300° C. to 900° C. Step b) can be performed at a temperature of, for example, 300° C. to 850° C., 300° C. to 800° C., 300° C. to 750° C., 300° C. to 700° C., 300° C. to 650° C., 300° C. to 600° C., 300° C. to 550° C., 300° C. to 500° C., 300° C. to 450° C., 300° C. to 400° C., 400° C. to 900° C., 400° C. to 850° C., 400° C. to 800° C., 400° C. to 750° C., 400° C. to 700° C., 400° C. to 650° C., 400° C. to 600° C., 400° C. to 550° C., 400° C. to 500° C., 500° C. to 900° C., 500° C. to 850° C., 500° C. to 800° C., 500° C. to 750° C., 500° C. to 700° C., 500° C. to 600° C., 600° C. to 900° C., 600° C. to 800° C., or 700° C. to 900° C. In some aspects, step b) is performed at a temperature of 300° C. to 800° C. In aspects wherein the salt is NaNO₃, step b) can be performed at, for example, 350° C. In other aspects, step b) is performed at a temperature less than 800° C.

Step b) can be performed in any equipment suitable to achieve the sufficient temperature for the salt to moltenize. In various aspects, step b) is performed in a furnace or a temperature controlled vacuum chamber. In some aspects, step b) further comprises stirring during the heating.

In various aspects, step b) is performed for a duration of 1 hour to 6 hours. Step b) can be performed, for example, for a duration of 1 hour to 5 hours, 1 hour to 4 hours, 1 hour to 3 hours, 1 hour to 2 hours, 2 hours to 6 hours, 2 hours to 5 hours, 2 hours to 4 hours, 2 hours to 3 hours, 3 hours to 6 hours, 3 hours to 5 hours, 3 hours to 4 hours, 4 hours to 6 hours, 4 hours to 5 hours, or 5 hours to 6 hours. Step b) can be performed for example, for 1 hour, 2 hours, 3 hours, 4 hours, 5 hours, or 6 hours.

### C. Curing the Cast Mixture

After heating the precursor composition in step b) to obtain a heated mixture, the method comprises step c), curing the heated mixture to form the composite concrete material. Curing the heated mixture can include, for example, pouring the heated mixture into a cast, curing the heated material, forming the composite concrete material, and removing it from the cast. Alternatively, the heated mixture can be deposited in a layer-by-layer technique using, for example, additive manufacturing infrastructure.

Thus, in some aspects, the method comprises pouring the heated mixture into a cast, curing the heated material, forming the composite concrete material, and removing it from the cast.

In some aspects, the method comprises 3-D printing the heated mixture to form the composite concrete material.

In contrast to conventional processes, in some aspects, the heated mixture can be fully cured in a manner of hours, such as 2-12 hours, rather than, for example, 3-7 days. The curing process can take as little as 2 hours, or the time required for cooling the composite concrete material to ambient temperature. Such an accelerated curing process may be advantageous, for example, in the field of pre-cast concrete for modular construction.

In some aspects, curing is performed at ambient temperature, such as at 25° C. In a further aspect, curing is performed at a temperature of 20° C. to 35° C. Curing can be performed, for example, at a temperature of 20° C. to 30° C., 20° C. to 25° C., 25° C. to 35° C., 25° C. to 30° C., or 30° C. to 35° C.

In some aspects, curing is performed under a vacuum. Without wishing to be bound by theory, vacuum curing may further densify the microstructure of the composite concrete material and enhance its engineering properties. This is in contrast to water-based concrete, for which the vacuum induced pressure causes dehydration, increases the porosity, and impairs the structural instability. Vacuum curing may be used when the methods described herein are employed in extraterrestrial construction.

In some aspects, curing is performed for 2 hours to 7 days. Curing can be performed, for example, for 2 hours to 6 days, 2 hours to 5 days, 2 hours to 4 days, 2 hours to 3 days, 2 hours to 2 days, 2 hours to 1 day, 2 hours to 12 hours, 12 hours to 6 days, 12 hours to 5 days, 12 hours to 4 days, 12 hours to 3 days, 12 hours to 2 days, 12 hours to 1 day, 1 day to 7 days, 1 day to 6 days, 1 day to 5 days, 1 day to 4 days, 1 day to 3 days, 1 day to 2 days, 2 days to 7 days, 2 days to 6 days, 2 days to 5 days, 2 days to 4 days, 2 days to 3 days, 3 days to 7 days, 3 days to 6 days, 3 days to 5 days, 3 days to 4 days, 4 days to 7 days, 4 days to 6 days, 4 days to 5 days, 5 days to 7 days, 5 days to 6 days, or 6 days to 7 days.

In some aspects, curing is performed for 2 hours to 12 hours. Curing can be performed, for example, for 2 hours to 10 hours, 2 hours to 8 hours, 2 hours to 6 hours, 2 hours to 4 hours, 4 hours to 12 hours, 4 hours to 10 hours, 4 hours to 8 hours, 4 hours to 6 hours, 6 hours to 12 hours, 6 hours to 10 hours, 6 hours to 8 hours, 8 hours to 12 hours, 8 hours to 10 hours, or 10 hours to 12 hours. Curing can be performed, for example, for no more than 12, 11, 10, 9, 8, 7, 6, 5, 4, 3, or for no more than about 2 hours.

Also disclosed herein is a composite concrete material formed by the methods described herein. The composite concrete material offers strength and durability up to 200% greater than its Portland cement counterpart. While Portland cement can achieve similar strength levels in 28 to 90 days, the composite concrete material provides comparable strength within few hours. Further, the composite concrete material is more thermally stable than zero-water concretes, such as sulfur concrete.

### ASPECTS

In view of the disclosure herein below are described certain more particularly described aspects of the inventions. These particularly recited aspects should not however be interpreted to have any limiting effect on any different claims comprising different or more general teachings described herein, or that the “particular” aspects are somehow limited in some way other than the inherent meanings of the language and formulas literally used therein.

Aspect 1: A dry method of making a composite concrete material, the method comprising: a) providing a water-free precursor composition which comprises by weight of the composition: i) 60% to 90% of a regolith simulant material or an aluminosilicate material; ii) 10% to 30% of a salt, wherein the salt is NaNO₃, KNO₃, LiNO₃, Li₂CO₃, K₂CO₃, Na₂CO₃, or a combination thereof; and iii) less than 20% of a base, wherein the total weight percent amount of components i), ii), and iii) does not exceed 100%, b) heating the precursor composition to a temperature sufficient to moltenize the salt, thereby providing a heated mixture; and c) curing the heated mixture to form the composite concrete material.

Aspect 2: The method of aspect 1, comprising pouring the heated mixture into a cast, curing the heated material, forming the composite concrete material, and removing it from the cast.

Aspect 3: The method of aspect 1, comprising 3-D printing the heated mixture to form the composite concrete material.

Aspect 4: The method of any of aspects 1-3, wherein the aluminosilicate material is fly ash, slag, silt, a clayey soil, volcanic ash, or a combination thereof.

Aspect 5: The method of any of aspects 1-4, wherein step b) is performed for a duration of 1 hour to 6 hours.

Aspect 6: The method of any of aspects 1-5, wherein curing is performed at a temperature of from 20° C. to about 35° C.

Aspect 7: The method of any of aspects 1-6, wherein step b) is performed at a temperature of 300° C. to 800° C.

Aspect 8: The method of any of aspects 1-7, wherein curing is performed under a vacuum.

Aspect 9: The method of any of aspects 1-8, wherein the base is NaOH, KOH, CaO or MgO.

Aspect 10: The method of any of aspects 1-9, wherein step c) is performed for 2 hours to 7 days.

Aspect 11: The method of any of aspects 1-10, wherein each of components i), ii), and iii) comprise particles having a mean particle diameter of less than 400 μm.

Aspect 12: The method of any of aspects 1-11, wherein step b) is performed in a furnace or a temperature controlled vacuum chamber.

Aspect 13: A composite concrete material formed by the method of any of aspects 1-12.

Aspect 14: A water-free composite precursor composition comprising, by weight: from 60% to 90% of a regolith simulant material or an aluminosilicate material; from 10% to 30% of a salt being NaNO₃, KNO₃, LiNO₃, Li₂CO₃, K₂CO₃, or Na₂CO₃; and less than 20% of a base being NaOH, KOH, CaO or MgO, wherein the total weight percent amount of components i), ii), and iii) does not exceed 100%.

Aspect 15: The composite precursor composition of aspect 14, wherein the aluminosilicate material is fly ash, slag, silt, a clayey soil, volcanic ash, or a combination thereof.

Aspect 16: The composite precursor composition of aspect 14 or 15, wherein each of components i), ii), and iii) comprise particles having a mean particle diameter of less than 400 μm.

### EXAMPLES

A composite concrete material was produced according to the following protocol, using lunar regolith stimulant, NaOH, and NaNO₃ at 350° C. for a duration of 3 hours.

1. The materials including precursor, molten salt, and alkali materials were dry mixed. All materials were in powder form (less than 400 microns). This may require the alkali materials to be ground if they are in pelleted or flakey forms.

2. The mixture was heated in a furnace, or a temperature controlled vacuumed chamber for 3 hours. The temperature was selected based on the melting point of the molten salt (e.g., 350° C. for NaNO₃)

3. The mixture was stirred at a specific interval.

4. The mixture was poured into molds based on the shape of the structural component.

5. The cast mixture was cured at ambient temperature to cool down.

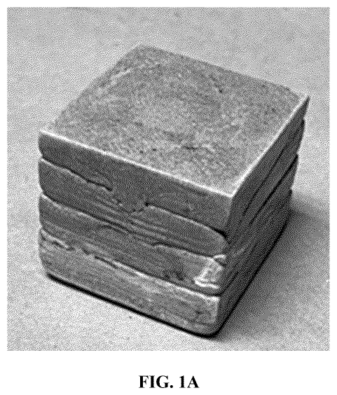

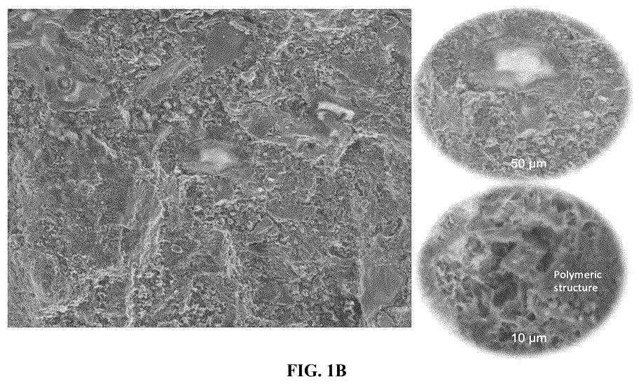

The polymeric structure produced was found to exhibit a strength of up to 60 MPa within 2 hours after completion of the process. The composite concrete material is shown in FIG. 1A and FIG. 1B. The same results were observed for KOH and NaNO₃ with the same procedure.

What is claimed is:

1. A dry method of making a composite concrete material, the method comprising:
a) providing a water-free precursor composition which comprises by weight of the composition:
i) 60% to 90% of a regolith simulant material or an aluminosilicate material;
ii) 10% to 30% of a salt, wherein the salt is NaNO₃, KNO₃, LiNO₃, Li₂CO₃, K₂CO₃, Na₂CO₃, or a combination thereof; and
iii) less than 20% of a base,
wherein the total weight percent amount of components i), ii), and iii) does not exceed 100%,
b) heating the precursor composition to a temperature sufficient to moltenize the salt, thereby providing a heated mixture; and
c) curing the heated mixture to form the composite concrete material.

2. The method of claim 1, comprising pouring the heated mixture into a cast, curing the heated material, forming the composite concrete material, and removing it from the cast.

3. The method of claim 1, comprising 3-D printing the heated mixture to form the composite concrete material.

4. The method of claim 1, wherein the aluminosilicate material is fly ash, slag, silt, a clayey soil, volcanic ash, or any combination thereof.

5. The method of claim 1, wherein step b) is performed for a duration of from 1 hour to 6 hours.

6. The method of claim 1, where curing is performed at a temperature of from 20 C to 35 C.

7. The method of claim 1, wherein step b) is performed at a temperature of 300° C. to 800° C.

8. The method of claim 1, wherein curing is performed under a vacuum.

9. The method of claim 1, wherein the base is NaOH, KOH, CaO or MgO.

10. The method of claim 1, wherein step c) is performed for 2 hours to 7 days.

11. The method of claim 1, wherein each of components i), ii), and iii) comprise particles having a mean particle diameter of less than 400 μm.

12. The method of claim 1, wherein step b) is performed in a furnace or a temperature controlled vacuum chamber.

13. A composite concrete material formed by the method of claim 1.

14. A water-free composite precursor composition comprising, by weight:
a) from 60% to 90% of a regolith simulant material or an aluminosilicate material;
b) from 10% to 30% of a salt being NaNO₃, KNO₃, LiNO₃, Li₂CO₃, K₂CO₃, or Na₂CO₃; and
c) less than 20% of an alkali compound being NaOH, KOH, CaO or MgO,
wherein the total weight percent amount of components i), ii), and iii) does not exceed 100%.

15. The composite precursor composition of claim 14, wherein the aluminosilicate material is fly ash, slag, silt, a clayey soil, volcanic ash, or a combination thereof.

16. The composite precursor composition of claim 14, wherein each of components i), ii), and
iii) comprise particles having a mean particle diameter of less than 400 μm.
